(19) United States
(12) Patent Application Publication
(10) Pub. No.: US 2026/0105531 A1
(43) Pub. Date: Apr. 16, 2026

(54) INFORMATION PROCESSING APPARATUS, SUPPORT METHOD, AND NON-TRANSITORY COMPUTER-READABLE MEDIUM

(71) Applicant: NEC Corporation, Tokyo (JP)

(72) Inventors: Takuma SATO, Tokyo (JP); Daiki Sato, Tokyo (JP); Etsuko Ichihara, Tokyo (JP); Kenei Tanabe, Tokyo (JP); Fumihiro Taniguchi, Tokyo (JP)

(73) Assignee: NEC Corporation, Tokyo (JP)

(21) Appl. No.: 19/347,899

(22) Filed: Oct. 2, 2025

(30) Foreign Application Priority Data
Oct. 11, 2024 (JP) 2024-179345

(51) Int. Cl. G06Q 40/08; G06F 40/40

(52) U.S. Cl. CPC G06Q 40/084; G06F 40/40

(57) ABSTRACT

An information processing apparatus includes an acquisition unit for acquiring event information indicating a target event which is an event likely to be associated with a payment cause of insurance, and an extraction unit for extracting a related payment cause related to the target event from a document describing a payment cause of insurance using an extraction model trained by machine learning to output a portion related to the data in the document using a set of the document and the data as an input. The information processing apparatus supports decision making in insurance payment assessment.

### INCORPORATION BY REFERENCE

This application is based upon and claims the benefit of priority from Japanese patent application No. 2024-179345, filed on Oct. 11, 2024, the disclosure of which is incorporated herein in its entirety by reference.

### TECHNICAL FIELD

The present disclosure relates to an information processing apparatus, a support method, and a non-transitory computer-readable medium.

### BACKGROUND ART

In a case where a payment cause of insurance occurs, a beneficiary of the insurance money submits necessary documents to an insurance company to claim the insurance money. Thereafter, the insurance company determines whether the insurance payment can be allowed (also referred to as payment assessment), and the insurance money is paid to the beneficiary if it is determined that the insurance money is allowed. For this reason, in a case where an event that is considered to be a payment target of the insurance money (for example, in the case of a medical insurance, illness or injury) occurs, the beneficiary needs to read back a contract clause or the like describing a cause of the insurance payment and confirm whether the occurred event is associated with the payment cause of insurance.

Here, as a document disclosing a related art related to insurance payment assessment, for example, JP 2022-55946 A below can be cited. JP 2022-55946 A discloses a non-payment possibility determination device that determines a possibility that insurance money is not to be paid by using insurance claim information from a customer and information described in a document related to the insurance claim.

### SUMMARY

It is not easy for many beneficiaries to read back the contract clause described in technical terms and check whether the occurred event is associated with the payment cause of insurance. This is because many of the beneficiaries do not have sufficient knowledge about insurance, and in a case of making a claim for insurance money, the beneficiaries are often in a mentally or physically unstable state.

Here, the non-payment possibility determination device disclosed in JP 2022-55946 A is a device for assisting the insurance company that has received the insurance claim in insurance payment assessment operation. For this reason, even if the device is used, the insurance claim cannot be facilitated. An example object of the present disclosure is to provide a technique for facilitating an insurance claim.

An information processing apparatus according to an example aspect of the present disclosure includes acquisition means for acquiring event information indicating a target event which is an event likely to be associated with a payment cause of insurance, and extraction means for extracting a related payment cause related to the target event from a document describing a payment cause of insurance using an extraction model trained by machine learning in such a way as to output a portion related to the data in the document using a set of the document and the data as an input.

Another information processing apparatus according to an example aspect of the present disclosure includes acquisition means for acquiring event information indicating a target event that is an event that may be associated with a payment cause of insurance; and determination means for determining whether the target event is associated with the payment cause by using a language model obtained by machine learning of natural language.

A support method according to an example aspect of the present disclosure causes at least one processor to execute acquisition processing for acquiring event information indicating a target event which is an event likely to be associated with a payment cause of insurance, and extraction processing for extracting a related payment cause related to the target event from a document describing a payment cause of insurance using an extraction model trained by machine learning in such a way as to output a portion related to the data in the document using a set of the document and the data as an input.

A support program according to an example aspect of the present disclosure causes a computer to function as acquisition means for acquiring event information indicating a target event which is an event likely to be associated with a payment cause of insurance, and extraction means for extracting a related payment cause related to the target event from a document describing a payment cause of insurance using an extraction model trained by machine learning in such a way as to output a portion related to the data in the document using a set of the document and the data as an input.

According to an exemplary aspect of the present disclosure, there is an exemplary effect that insurance claim can be facilitated.

### BRIEF DESCRIPTION OF DRAWINGS

FIG. 1 is a block diagram illustrating a configuration of an information processing apparatus according to the present disclosure;

FIG. 2 is a flowchart illustrating a flow of a support method according to the present disclosure;

FIG. 3 is a block diagram illustrating a configuration of another information processing apparatus according to the present disclosure;

FIG. 4 is a diagram illustrating an extraction example of a related payment cause;

FIG. 5 is a diagram illustrating an example of determining whether a target event is associated with a related payment cause;

FIG. 6 is a diagram illustrating an example of a user interface (UI) screen that receives a correction instruction in a natural language;

FIG. 7 is a view illustrating an example of a UI screen that receives correction or supplementation of a description of a target event;

FIG. 8 is a diagram illustrating an example of a UI screen that receives an input of an explanatory sentence of history information;

FIG. 9 is a flowchart illustrating a flow of processing executed by the information processing apparatus illustrated in FIG. 3;

FIG. 10 is a block diagram illustrating a configuration of an information processing apparatus according to a reference example; and

FIG. 11 is a block diagram illustrating a configuration of a computer that functions as an information processing apparatus according to the present disclosure.

### EXAMPLE EMBODIMENT

Hereinafter, example embodiments of the present invention will be described. However, the present invention is not limited to the exemplary example embodiments to be described below, and various modifications can be made within the scope described in the claims. For example, example embodiments obtained by appropriately combining techniques (some or all of things or methods) adopted in the following exemplary example embodiments can also be included in the scope of the present invention. Example embodiments obtained by appropriately omitting some of the techniques adopted in the following exemplary example embodiments can also be included in the scope of the present invention. Effects mentioned in the following exemplary example embodiments are examples of effects expected in the exemplary example embodiments, and do not define extensions of the present invention. That is, example embodiments that do not achieve the effects mentioned in the following exemplary example embodiments can also be included in the scope of the present invention.

### First Exemplary Example Embodiment

A first exemplary example embodiment that is an example of an example embodiment of the present invention will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technique illustrated in the drawings referred to for describing the present exemplary example embodiment can also be adopted in the other exemplary example embodiments included in the present disclosure within a range in which no particular technical problem occurs.

### (Configuration of Information Processing Apparatus 1)

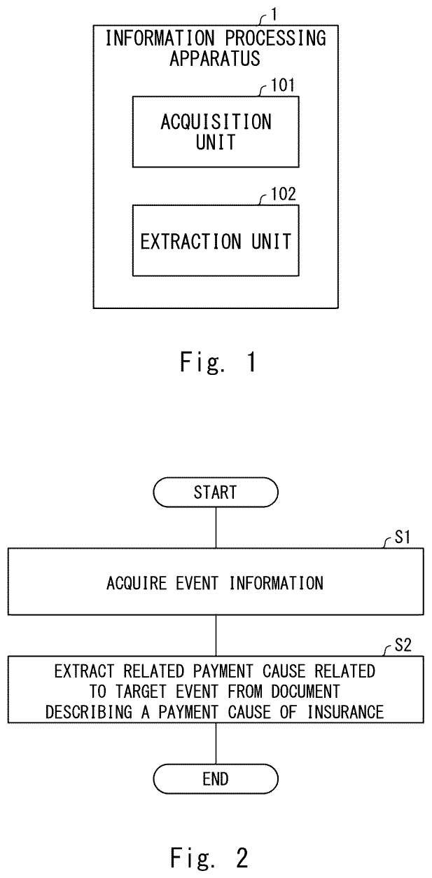

A configuration of an information processing apparatus 1 according to the present exemplary example embodiment will be described with reference to FIG. 1. FIG. 1 is a block diagram illustrating a configuration of the information processing apparatus 1. As illustrated in FIG. 1, the information processing apparatus 1 includes an acquisition unit 101 and an extraction unit 102.

The acquisition unit 101 acquires event information indicating a target event which is an event that may be associated with a payment cause of insurance. The “event” can also be rephrased as a matter, a fact, an event, or the like. The “payment cause” indicates a fact or event that causes insurance payment, and can be rephrased as a requirement for insurance payment, a provision for insurance payment, a condition for insurance payment, and the like. The “insurance money” includes not only insurance money (for example, a life insurance money or the like) to be paid at the time of termination of the insurance contract but also a benefit (for example, a hospital benefit or the like) to be paid during the continuation of the insurance contract. The insurance from which the insurance claim is made is any insurance. For example, the insurance may be an insurance related to the life or health of an insured person such as a life insurance, an endowment insurance, or a medical insurance, or may be an insurance related to owned property such as an automobile insurance or a fire insurance.

The “event information” may indicate at least one target event that may be associated with a payment cause. For example, the acquisition unit 101 may acquire, as the event information, text data describing an event for which the insured person considers that there is a possibility that the insurance money will be paid. In the following, an example will be described in which the insured person who is the beneficiary of the insurance money uses the information processing apparatus 1 to consider the insurance claim, but a person who considers the insurance claim, in other words, a user of the information processing apparatus 1 is any person.

For example, the acquisition unit 101 may acquire history information indicating a history related to the payment cause as the event information. The history information may indicate a history that may be associated with a payment cause. For example, in a case where a target insurance is an insurance related to health of an insured person such as a medical insurance, the acquisition unit 101 may acquire history information indicating injury and illness history, a hospital history, a hospital visit history, a history of prescribed medicine, a history of clinical examination by a doctor, a history of medical test results, and the like of the insured person.

Any method of acquiring the event information is applicable. The acquisition unit 101 may acquire a plurality of types of event information. For example, the acquisition unit 101 may acquire both text data input by the insured person and history information recorded in a predetermined database (for example, a database in which various types of information regarding medical insurance and the like are recorded in association with individual identification information allocated to each of the people) as the event information.

The extraction unit 102 extracts a payment cause related to the target event indicated in the event information acquired by the acquisition unit 101 from the document describing a payment cause of insurance using an extraction model machine-learned in such a way as to output a portion related to the data in the document using a set of the document and the data as an input. Since the payment cause extracted by the extraction unit 102 is a payment cause related to the target event, this payment cause is referred to as a related payment cause below.

The above “extraction model” may be any model that can be used to extract a related payment cause from a document describing the payment cause of insurance. For example, a model that divides a document describing a payment cause into texts in a predetermined unit (for example, for each sentence or for each payment cause), calculates a score indicating similarity of the content with the target event for each text obtained by the division, and outputs a text in which the calculated score is equal to or more than a predetermined threshold can be used as the extraction model. Such a model can be generated, for example, by machine learning using training data in which the score in a set of text and data is associated as ground truth data with respect to the set of text and data. The data paired with the text is typically text data, but it is also possible to use data in another format such as image data.

The “extraction model” described above may be a general-purpose model that can be used for applications other than the extraction of the related payment cause, or may be a model obtained by fine-tuning a general-purpose model for the extraction of the related payment cause. The extraction model may be included in the information processing apparatus 1 or may be included in another apparatus. In the latter case, the extraction unit 102 uses the extraction model via another device including the extraction model.

The “document describing the payment cause of insurance” may be a document describing at least a part of the payment cause. For example, an insurance policy of the insurance, a manual of the insurance, a Q & A collection of the insurance, a web page describing the insurance (for example, the insured person's My Page), a contract clause of the insurance, or the like can be used as a document describing the payment cause of insurance.

As described above, the information processing apparatus 1 according to the present exemplary example embodiment includes an acquisition unit 101 for acquiring event information indicating a target event which is an event likely to be associated with a payment cause of insurance, and an extraction unit 102 for extracting a related payment cause related to the target event from a document describing a payment cause of insurance using an extraction model trained by machine learning in such a way as to output a portion related to the data in the document using a set of the document and the data as an input.

According to the above configuration, it is possible to extract the related payment cause related to the target event from the document describing the payment cause of insurance. As a result, the insured person does not need to perform complicated work of searching for a related payment cause related to the target event from the document describing the payment cause of insurance. Therefore, according to the information processing apparatus 1, it is possible to obtain an effect of facilitating the insurance claim.

According to the information processing apparatus 1, it is also possible to support decision making in payment assessment, that is, determination as to whether the target event is associated with a payment cause. In this manner, the information processing apparatus 1 can also contribute to improvement in efficiency of payment assessment in an insurance company or the like.

How the extracted related payment cause is used in an insurance claim or the like is optional. For example, the information processing apparatus 1 may present the extracted related payment cause to the insured person as reference information. In this case, the insured person may determine whether to claim the insurance payment with reference to the presented related payment cause, or may claim the payment based on the presented related payment cause. In a case where the information processing apparatus 1 is used for payment assessment, the extracted related payment cause may be presented to an assessor as reference information. For example, as described in a second exemplary example embodiment to be described later, it may be automatically determined whether the target event is associated with a related payment cause, and a determination result may be presented.

### (Support Program)

The functions of the information processing apparatus 1 described above can also be achieved by a program. A support program according to the present exemplary example embodiment is a support program for an insurance claim causes a computer to function as acquisition means for acquiring event information indicating a target event which is an event likely to be associated with a payment cause of insurance, and extraction means for extracting a related payment cause related to the target event from a document describing a payment cause of insurance using an extraction model trained by machine learning in such a way as to output a portion related to the data in the document using a set of the document and the data as an input. According to this support program, it is possible to obtain an effect of facilitating an insurance claim.

### (Flow of Support Method)

A flow of a support method according to the present exemplary example embodiment will be described with reference to FIG. 2. FIG. 2 is a flowchart illustrating a flow of the support method. An executing entity of each step in this support method may be a processor included in the information processing apparatus 1, may be a processor included in another apparatus, or an executing entity of each step may be a processor provided in each of different apparatuses.

In S1 (acquisition processing), at least one processor acquires event information indicating a target event which is an event that may be associated with a payment cause of insurance.

In S2 (extraction processing), at least one processor extracts a related payment cause related to a target event indicated in the event information acquired in S1, from the document describing a payment cause of insurance using an extraction model trained by machine learning in such a way as to output a portion related to the data in the document by using a set of the document and data as an input.

As described above, the support method according to the present exemplary example embodiment is a support method for an insurance claim for causing at least one processor to execute acquisition processing for acquiring event information indicating a target event which is an event likely to be associated with a payment cause of insurance, and extraction processing for extracting a related payment cause related to the target event from a document describing a payment cause of insurance using an extraction model trained by machine learning in such a way as to output a portion related to the data in the document using a set of the document and the data as an input. According to this support method, it is possible to obtain an effect of facilitating an insurance claim.

### Second Exemplary Example Embodiment

A second exemplary example embodiment that is an example embodiment of the present invention will be described in detail with reference to the drawings. Components having the same functions as the components described in the above-described exemplary example embodiment will be denoted by the same reference numerals, and the description thereof will be appropriately omitted. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### (Configuration of Information Processing Apparatus 1A)

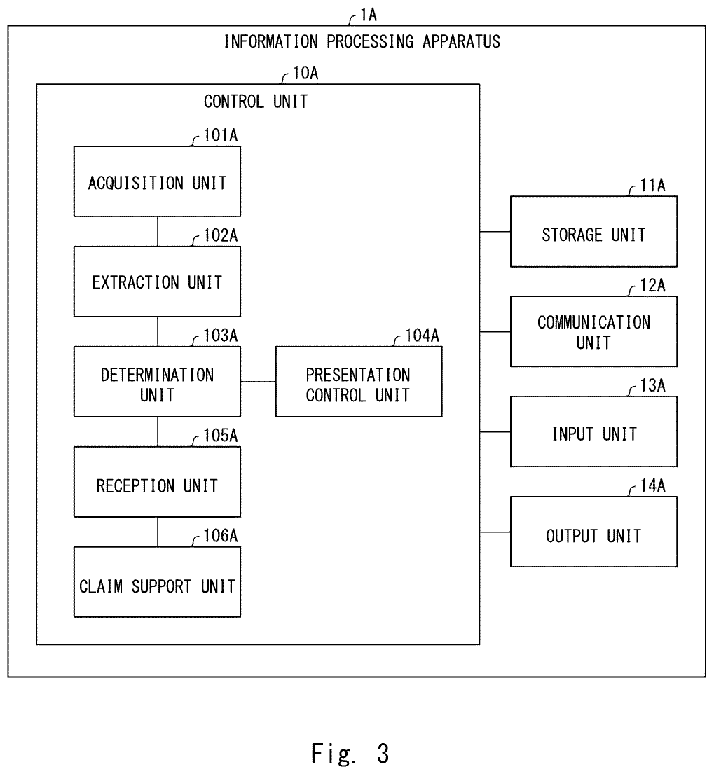

A configuration of an information processing apparatus 1A according to the present exemplary example embodiment will be described with reference to FIG. 3. FIG. 3 is a block diagram illustrating the configuration of the information processing apparatus 1A. The information processing apparatus 1A is an apparatus having a function of supporting an insurance claim. The information processing apparatus 1A may be a local apparatus used by individual users, or may be a server that provides an insurance claim support service to a plurality of users.

As illustrated, the information processing apparatus 1A includes a control unit 10A that integrally controls units of the information processing apparatus 1A, and a storage unit 11A that stores various types of data to be used by the information processing apparatus 1A. The information processing apparatus 1A includes a communication unit 12A for the information processing apparatus 1A to communicate with another apparatus, an input unit 13A that receives an input to the information processing apparatus 1A, and an output unit 14A for the information processing apparatus 1A to output data. The control unit 10A includes an acquisition unit 101A, an extraction unit 102A, a determination unit 103A, a presentation control unit 104A, a reception unit 105A, and a claim support unit 106A.

Similarly to the acquisition unit 101 of the first exemplary example embodiment, the acquisition unit 101A acquires event information indicating a target event that is an event that may be associated with a payment cause of insurance. The acquisition unit 101A may also acquire various types of information (for example, identification information on an insured person such as a name and a date of birth, an identification number of a target insurance, and the like) necessary for an insurance claim other than the payment cause.

Similarly to the extraction unit 102 of the first exemplary example embodiment, the extraction unit 102A extracts a related payment cause related to the target event from the document describing the payment cause of insurance by using an extraction model trained by machine learning in such a way as to output a portion related to the data in the document using a set of the document and the data as an input. Hereinafter, the extraction model used by the extraction unit 102A is referred to as an extraction model M1.

The determination unit 103A determines whether the target event indicated in the event information acquired by the acquisition unit 101A is associated with a payment cause by using a language model trained by machine learning on a natural language. More specifically, the determination unit 103A determines whether the target event indicated in the event information acquired by the acquisition unit 101A is associated with the related payment cause extracted by the extraction unit 102A.

However, the extraction of the related payment cause by the extraction unit 102A is not an essential premise in the determination by the determination unit 103A. For example, the determination unit 103A may perform processing of determining whether the target event indicated in the event information acquired by the acquisition unit 101A is associated with a payment cause for each of the causes of insurance payment. Although the number of times of determination by the determination unit 103A is increased as compared with the case of extracting the related payment cause, it is possible to support the insurance claim even in a case of adopting such processing.

Here, machine learning on natural language more specifically means learning of the arrangement of components (words and the like) in a sentence in a natural language and the arrangement of sentences in a text. Examples of the language model trained on natural language include bidirectional encoder representations from transformers (BERT), Robustly optimized BERT approach (RoBERTa), efficiently learning an encoder that classifies token replacements accurately (ELECTRA), and the like. Hereinafter, the language model used by the determination unit 103A is referred to as a language model M2.

In the present exemplary example embodiment, an example in which the language model M2 is a model that accepts an input of a prompt in a text format described in a natural language and outputs an answer in the natural language will be described. However, the language model M2 may be a model capable of receiving input of data in a format other than text data such as an image.

The language model M2 may be a general-purpose language model that can be used for applications other than the inference of whether the target event is associated with the payment cause, or may be a general-purpose language model finely tuned for the inference of whether the target event is associated with the payment cause. The language model M2 may be included in the information processing apparatus 1A or may be included in another apparatus. In the latter case, the determination unit 103A uses the language model M2 via another device including the language model M2.

The presentation control unit 104A presents various types of information regarding insurance claim support. For example, the presentation control unit 104A presents the determination result of the determination unit 103A. For example, the presentation control unit 104A may present the inference result output by the language model M2. Although details will be described later, the presentation control unit 104A may present the inference result together with the basis of the inference. Any method of presenting the information is applicable. For example, the presentation control unit 104A may present information by causing the output unit 14A to output the information, or may present information by causing another device to output the information via the communication unit 12A. The information can be presented in any form such as display, printing, voice, or a combination thereof.

The reception unit 105A receives various instructions regarding insurance claim support. For example, the reception unit 105A receives a correction instruction for a result of inference by the language model M2. Any method of receiving the instruction is applicable. For example, the reception unit 105A may receive an instruction input via the input unit 13A, or may receive an instruction from another device via the communication unit 12A.

The claim support unit 106A supports an insurance claim. For example, the claim support unit 106A may notify a predetermined notification destination (insurance company or the like) of the target event determined to be associated with the related payment cause by the determination unit 103A together with the identification information on the insured person and the insurance to be claimed, and claim insurance payment.

Since the determination result of the determination unit 103A is not necessarily correct, it is preferable to present the target event to the insured person, to have the insured person confirm the validity, and then make a claim. The content of the support by the claim support unit 106A may be any content as long as it can reduce the burden on the insured person in the insurance claim, and is not limited to automatically claim the insurance.

For example, in a case where the determination unit 103A determines that the target event is associated with the related payment cause, the claim support unit 106A may perform processing of ordering an application form or the like necessary for a claim for insurance money from an insurance company or the like. In this case, the claim support unit 106A may transmit a notification indicating the identification information on the insured person and the insurance to be claimed to a predetermined notification destination such as a counter of an insurance company, and request transmission of an application form or the like.

For example, in a case where the related payment cause relates to injury and illness of the insured person and a doctor's medical certificate is necessary for insurance claim, the claim support unit 106A may perform processing of acquiring the medical certificate. In this case, the claim support unit 106A may transmit the form of the medical certificate to the doctor in charge of the insured person, and request the doctor to fill in and return the medical certificate.

It is not essential to provide the claim support unit 106A. In a case where the claim support unit 106A is not provided, the insured person may consider whether to claim the insurance with reference to the determination result of the determination unit 103A presented by the presentation control unit 104A.

As described above, the information processing apparatus 1A includes the acquisition unit 101A that acquires the event information indicating the target event that may be associated with the payment cause of insurance, and the extraction unit 102A that extracts the related payment cause, which is the payment cause related to the target event, from the document describing the payment cause of insurance using the extraction model M1 trained by machine learning in such a way as to output a portion related to the data in the document with the set of document and data as an input. Therefore, according to the information processing apparatus 1A, similarly to the information processing apparatus 1, it is possible to obtain an effect that the insurance claim can be facilitated.

As described above, the information processing apparatus 1A includes the determination unit 103A that determines whether the target event is associated with the related payment cause by using the language model M2 trained by machine learning on natural language, and the presentation control unit 104A that presents the determination result of the determination unit 103A. As a result, in addition to the effect obtained by the information processing apparatus 1, it is possible to obtain an effect that it is possible to smoothly determine whether to claim insurance based on an objective determination result as to whether the target event is associated with a related payment cause.

The determination by the determination unit 103A can be omitted. In a case where the determination by the determination unit 103A is omitted, the presentation control unit 104A may present the related payment cause extracted by the extraction unit 102A. In this case, the insured person may determine whether the claim can be made by comparing the presented related payment cause with the target event. As a result, it is possible to save the time and effort of the insured person to search for the payment cause related to the target event from the document defining the payment cause, and to facilitate the insurance claim.

As described above, the information processing apparatus 1A includes the acquisition unit 101A that acquires the event information indicating the target event that is an event that may be associated with the payment cause of insurance, and the determination unit 103A that determines whether the target event is associated with the payment cause by using the language model M2 trained by machine learning on natural language. According to the information processing apparatus 1A, it is possible to obtain an objective determination result as to whether the target event is associated with the payment cause. Therefore, it is possible to obtain an effect that the insurance claim can be facilitated.

### (Exemplary Extraction of Related Payment Cause)

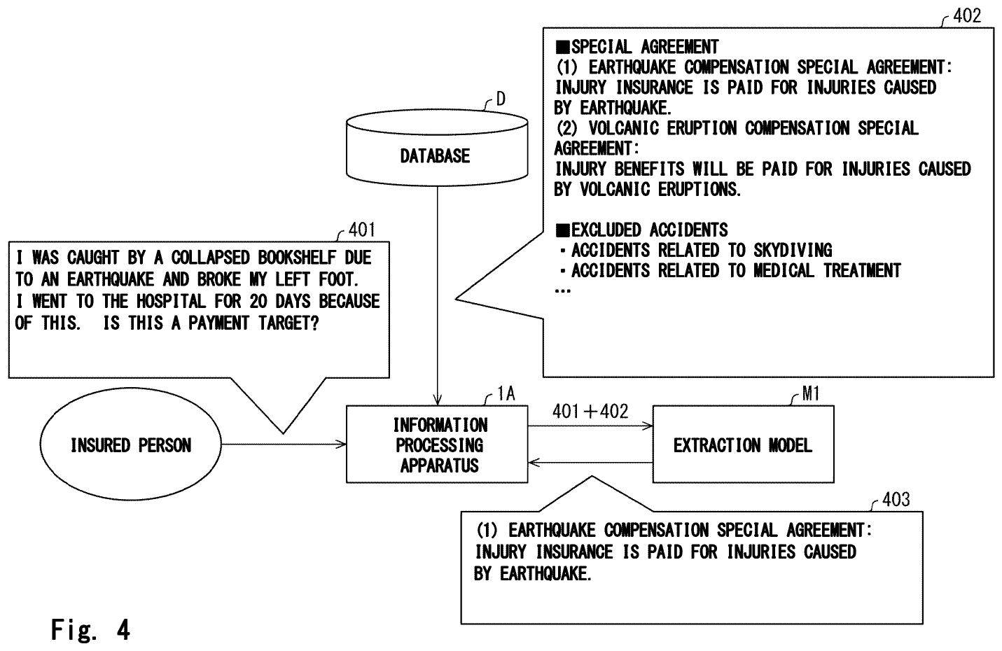

An example of extraction of a related payment cause by the information processing apparatus 1A will be described with reference to FIG. 4. FIG. 4 is a diagram illustrating an example of extraction of a related payment cause. In the example of FIG. 4, the insured person inputs event information 401 to the information processing apparatus 1A. The input event information 401 is acquired by the acquisition unit 101A included in the information processing apparatus 1A. An input person of the event information 401 may be other than the insured person.

The event information 401 indicates an event considered by the insured person to be possibly associated with the payment cause, that is, the above-described target event. The event information 401 is a content asking whether the target event is a payment target of the insurance money, in other words, whether the event is associated with a payment cause. Since the extraction unit 102A extracts the related description by the extraction model M1, the event information 401 freely described by the subject in natural language can be handled.

For example, the insured person may input the event information 401 via the input unit 13A, or may input the event information 401 via the communication unit 12A using his/her own terminal device or the like. The insured person may input the event information 401 as text data or as voice data. In the latter case, the acquisition unit 101A can acquire the event information 401 in text format by causing the information processing apparatus 1A or another voice recognition apparatus to perform voice recognition on the input voice data.

In the example of FIG. 4, the information processing apparatus 1A (more specifically, the acquisition unit 101A) acquires, from the database D, the document 402 in which the payment cause of insurance of the target insurance, that is, the insurance in which the insured person is the beneficiary of the insurance money is described. Hereinafter, the insurance is referred to as a target insurance. In a case where the document 402 is acquired from the database D, a document describing the payment cause of various types of insurance may be recorded in the database D in association with identification information on the insurance. Then, identification information of the target insurance may be input to the information processing apparatus 1A. As a result, the acquisition unit 101A can acquire the document 402 in which the payment cause of the target insurance is described from the database D. Any method of acquiring the document 402 is applicable, and is not limited to the above example. For example, the insured person may input the document 402 to the information processing apparatus 1A together with the event information 401, or the document 402 may be stored in the information processing apparatus 1A in advance. For example, the information processing apparatus 1A may be caused to read a web page describing the payment cause of the target insurance as the document 402.

Next, the information processing apparatus 1A (more specifically, the extraction unit 102A) inputs the event information 401 and the document 402 acquired by the acquisition unit 101A as described above to the extraction model M1. As a result, the related payment cause 403 is output from the extraction model M1.

The related payment cause 403 is a payment cause related to the target event indicated in the event information 401 among the payment causes specified in the document 402. Specifically, the related payment cause 403 indicates a payment cause of “(1) Earthquake compensation special agreement: Injury insurance is paid for injuries caused by earthquake.” related to a target event of “I was caught by a collapsed bookshelf due to an earthquake and broke my left foot. I went to the hospital for 20 days because of this. Is this a payment target?” indicated in the event information 401.

Although details will be described below, the determination unit 103A determines whether the target event indicated in the event information 401 is associated with the related payment cause 403 extracted as described above. As described above, the presentation control unit 104A may present the extracted related payment cause 403 to the insured person. In this case, the presentation control unit 104A may cut out and present the portion of the related payment cause 403 from the document 402, or may present the document 402 in which the portion of the related payment cause 403 is highlighted. The highlight may be performed in a mode in which the highlighted portion and the non-highlighted portion can be identified. For example, the presentation control unit 104A may highlight the portion of the related payment cause 403 in the document 402 by changing the background color of the highlighted portion, changing the text font of the highlighted portion, or the like.

(Example of Determination as to Whether Target Event is Associated with Related Payment Cause)

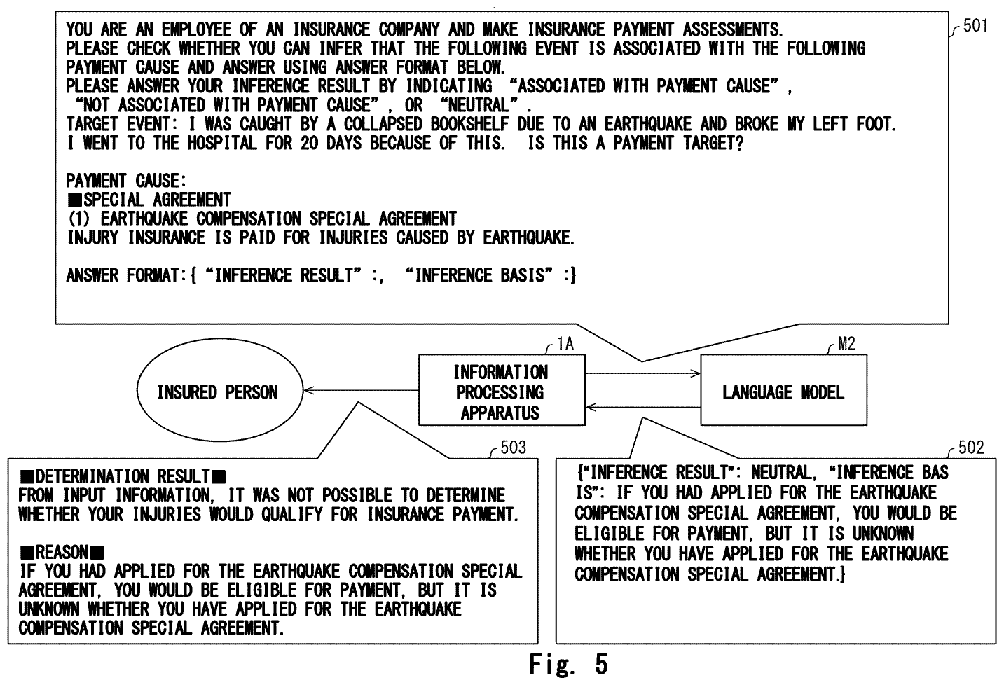

FIG. 5 is a diagram illustrating an example of determining whether the target event is associated with a related payment cause. As described above, this determination is performed by the determination unit 103A. A language model M2 is used for this determination. Therefore, the determination unit 103A generates a prompt describing the content of the instruction for the language model M2 and inputs the prompt to the language model M2.

In the example of FIG. 5, the information processing apparatus 1A (more specifically, the determination unit 103A) inputs a prompt 501 to the language model M2. A prompt 501 includes the related payment cause 403 illustrated in FIG. 4 and the target event indicated in the event information 401 illustrated in FIG. 4, and instructs to infer a relationship between the related payment cause 403 and the target event.

More specifically, the target event indicated in the event information 401 is described in the item of “target event” in the prompt 501. The related payment cause 403 is described in the item of “payment cause” in the prompt 501. The prompt 501 includes a sentence “You are an employee of an insurance company and make insurance payment assessments.”. It is not essential to include such a sentence, but the inference accuracy can be expected to be improved by including such a sentence.

The prompt 501 is content instructing to check whether it can be inferred that the target event is associated with the payment cause. The expression in the prompt can be appropriately changed within a range in which a desired inference result can be obtained. For example, the determination unit 103A may generate a prompt having a different expression of the inference instruction according to the target event, the type of the target insurance, the language model to be used, and the like.

The prompt 501 includes an “answer format” and has contents instructing to answer in this answer format. In this way, by specifying the answer format, it is possible to obtain an inference result in a desired format. This answer format includes an item “inference basis”. By including such items, it is possible to cause the language model M2 to output the inference result and the grounds of the inference. The instruction to output the grounds of inference may be made by including a text such as “Please answer the grounds together with the inference result” in the prompt, for example.

The prompt 501 may include a text specifying an output condition. For example, a text such as “In a case where a plurality of target events is listed, it is necessary to infer whether each event is associated with a payment cause.” or “The number of elements included in the answer format needs to match the number of target events.” may be included in the prompt 501. This makes it possible to enhance the inference accuracy of the language model M2.

In the prompt 501, contents other than the “target event” and the “payment cause” are fixed. For this reason, a portion other than the contents of the “target event” and the “payment cause” in the prompt 501 may be stored in the storage unit 11A or the like as a fixed template. As a result, the determination unit 103A can generate the prompt 501 by inputting the target event indicated in the event information 401 acquired by the acquisition unit 101A and the related payment cause 403 extracted by the extraction unit 102A to the template.

The inference result 502 illustrated in FIG. 5 illustrates an example of an inference result obtained by inputting the prompt 501 to the language model M2. The inference result 502 indicates the result of inferring the relationship between the related payment cause and the target event in the form of the answer format indicated in the prompt 501. Specifically, the inference result 502 indicates an inference result indicating that whether the target event indicated in the event information 401 is associated with a related payment cause is “neutral”. In the inference result 502, the basis of the inference is indicated together with the inference result.

The prompt 501 in FIG. 5 is a prompt for determining whether one target event is associated with the related payment cause 403, but a prompt for determining whether each target event is associated with the related payment cause 403 may be used for a plurality of target events. In a case where there are a plurality of related payment causes 403, a prompt for determining whether the target event is associated with any of the plurality of related payment causes 403 or associated with none of the related payment causes 403 may be used.

In what form the inference result is output can be specified by a prompt. For example, the determination unit 103A may generate a prompt for instructing to answer with two choices of being associated with the payment cause and being not associated with the payment cause, or may generate a prompt for instructing to answer with three choices including “neutral” as in the example of FIG. 5. For example, the determination unit 103A may generate a prompt to instruct to output a numerical value (for example, a numerical value of 0 to 1) indicating the degree of possibility of being associated with the related payment cause. In this case, in a case where a numerical value output for a combination of a certain target event and a certain related payment cause is equal to or more than a predetermined threshold, the determination unit 103A may determine that the target event is associated with the related payment cause.

FIG. 5 illustrates a screen example 503 for presenting the inference result 502. In the screen example 503, the determination result of the determination unit 103A as to whether each target event is associated with a related payment cause is presented together with the reason. The presentation control unit 104A can generate and present a screen such as the screen example 503 by using the determination result of the determination unit 103A and the inference basis indicated in the inference result 502. In this manner, the presentation control unit 104A may present the determination result of the determination unit 103A to the insured person. As described above, the presentation control unit 104A may present the inference basis output by the language model M2 to the insured person as a determination material for determining whether the inference result is appropriate.

In a case where the output unit 14A has a function of displaying and outputting an image, the presentation control unit 104A may cause the output unit 14A to display a screen. The presentation control unit 104A may cause a display device (for example, a display device included in a terminal device used by an insured person) outside the information processing apparatus 1A to display the screen via the communication unit 12A.

As described above, the determination unit 103A may generate the prompt 501 that includes the related payment cause and the target event and instructs to infer the relationship between the related payment cause and the target event, and determine whether the target event is associated with the related payment cause based on the inference result 502 that is an output obtained by inputting the generated prompt 501 to the language model M2. Accordingly, it is possible to appropriately determine whether the target event is associated with the related payment cause.

### (Presentation and Re-Inference of Inference Result)

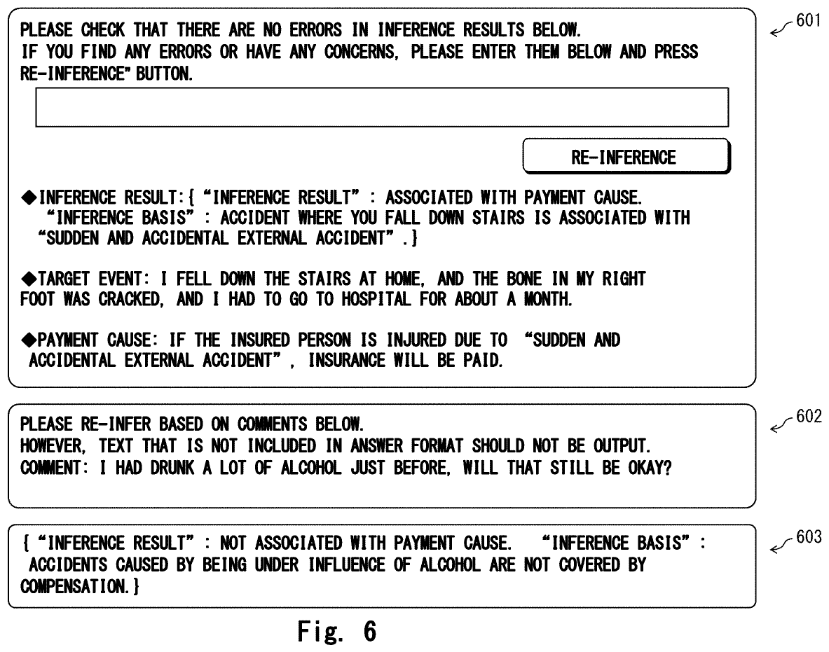

The reception unit 105A may receive a correction instruction representing a correction content in a natural language for the inference result. This will be described with reference to FIG. 6. FIG. 6 is a diagram illustrating an example of a UI screen that receives a correction instruction in a natural language. FIG. 6 also illustrates a prompt 602 for instructing re-inference based on a correction instruction in a natural language and a re-inference result 603 obtained by inputting the prompt 602 to the language model M2, in addition to the screen example 601 which is an example of a UI screen for receiving a correction instruction in a natural language.

In a screen example 601, the inference result of the language model M2, the event (target event) and the payment cause (related payment cause) that are the target of the inference are illustrated, and at the same time, a text that prompts the user to confirm whether there is an error or a noticed point in the inference result and requests the user to input the content of the error or the like and instruct the re-inference if there is the error or the like is illustrated. In the screen example 601, a text box for inputting the correction content and a button (software key) for instructing re-inference are also displayed.

By presenting a UI screen such as the screen example 601 to the insured person, the presentation control unit 104A can cause the insured person to confirm the inference result. The reception unit 105A can also receive correction for the inference result and input of supplementary information regarding inference via a UI screen such as the screen example 601.

In the screen example 601, in a case where a correction content or supplementary information is input to a text box and a button for instructing re-inference is operated, the reception unit 105A receives the input correction content as a correction instruction. For example, the reception unit 105A may receive a correction instruction in which the reason why the inference result is an error is described in a natural language. For example, the reception unit 105A may receive a correction instruction in which whether the target event to be inferred is associated with a related payment cause is described in natural language. For example, the reception unit 105A may receive, as the correction instruction, supplementary information to be considered in the inference as to whether the target event is associated with the related payment cause.

Then, the determination unit 103A redetermines whether the target event is associated with the related payment cause based on the correction instruction received by the reception unit 105A. For example, the determination unit 103A may generate the prompt 602 illustrated in FIG. 6 and input the prompt to the language model M2, and may redetermine whether the target event is associated with the related payment cause based on the re-inference result 603 output from the language model M2.

The prompt 602 is a prompt including the text of the correction instruction received by the reception unit 105A, and instructing to infer the relationship between the target event and the related payment cause based on the correction instruction. The prompt 602 includes a text “However, text that is not included in the answer format should not be output.”. In this manner, the prompt for instructing re-inference may also include a text specifying an output condition. As a result, it is possible to prevent unnecessary content (for example, text such as “Sorry. I will output again.” and “Contents have been updated.”) from being output from the language model M2, and to prevent trouble from occurring in input to the input form of the insurance, and the like. The prompt 602 can also be generated using a predetermined template similarly to the prompt 501 illustrated in FIG. 5. Similarly to the prompt 501, the target event, the related payment cause, the answer format, and the like may be described in the prompt 602.

In the re-inference result 603 illustrated in FIG. 6, the inference result of the relationship between the target event and the related payment cause has changed from that illustrated on the UI screen 601 by reflecting the “comment” indicated in the prompt 602, that is, the content of the correction instruction. Specifically, in the re-inference result 603, the inference result as to whether the target event of “I fell down the stairs at home, and the bone in my right foot was cracked, and I had to go to hospital for about a month.” is associated with a related payment cause has been changed to “not associated with a payment cause”. The inference basis has been changed to a sentence “accidents caused by being under influence of alcohol are not covered by compensation”. As described above, the re-inference is performed using the prompt 602 including the sentence in the natural language received as the correction instruction, in such a way that the re-inference result 603 reflecting the content of the correction instruction can be output.

As described above, the determination unit 103A may generate a prompt (for example, the prompt 501 in FIG. 5) instructing to output a basis of the inference together with the inference result of the relationship between the related payment cause and the target event. Then, the presentation control unit 104A may present the inference result output by the language model M2 together with the basis. As a result, in addition to the effect obtained by the information processing apparatus 1, it is possible to obtain an effect that the appropriateness/inappropriateness of the inference result of the language model M2 can be examined using the basis thereof as a determination material. The presentation control unit 104A may present the determination result of the determination unit 103A together with the above grounds instead of the inference result output by the language model M2.

As described above, the information processing apparatus 1A includes the reception unit 105A that receives a correction instruction for the inference result. Then, the determination unit 103A redetermines whether the target event is associated with the related payment cause based on the correction instruction received by the reception unit 105A. As a result, in addition to the effect obtained by the information processing apparatus 1, it is possible to correct an error in the inference result and enable the insured person to correctly claim payment. The above “correction instruction” includes not only an instruction to correct the inference result but also an instruction to perform re-inference based on supplementary information including supplementary information to be considered in the inference.

As described above, the reception unit 105A may receive a correction instruction representing a correction content in a natural language. In this case, the determination unit 103A generates a prompt (for example, the prompt 602 in FIG. 6) including the correction instruction received by the reception unit 105A and instructing to infer the relationship between the target event and the related payment cause based on the correction instruction, and redetermines whether the target event is associated with the related payment cause based on the output obtained by inputting the generated prompt to the language model M2. As a result, in addition to the effect obtained by the information processing apparatus 1, it is possible to obtain an effect that appropriate redetermination can be performed by considering the intention of the correction instruction.

As an example in which the intention of the correction instruction can be grasped, there is absorption of notation distortion. For example, as in the example of FIG. 6, it is assumed that an inference result that the target event of “I fell down the stairs at home, and the bone in my right foot was cracked, and I had to go to hospital for about a month.” is associated with a related payment cause of “If the insured person is injured due to “sudden and accidental external accident”, insurance will be paid.” has been obtained. In this case, for example, even if the insured person inputs a sentence such as “Is there any problem even if he/she is drunk?” or “I had two or three bottles of beer at that time” different from the “I had drunk a lot of alcohol just before, will that still be okay?” as in the example of FIG. 6, the result of the re-inference can be determined as “not associated with the payment cause”.

In a case where a correction instruction representing a correction content in a natural language is received, there is also an advantage that the content of the correction instruction can be reflected in other inferences. For example, it is assumed that a correction instruction of “there is no hospital facility in X clinic” is input in response to the inference result that the target event of “I was diagnosed with diabetes at X Clinic and received treatment there for a while.” is associated with a related payment cause of “I will pay the benefit for hospitalization due to a lifestyle disease”. In this case, the determination unit 103A can not only correct the inference result regarding the target event to “not associated with the payment cause”, but also update other inference results based on the fact that there is no hospital facility in the X clinic.

### (Reuse of Correction Instruction)

The content of the correction instruction as described above may be recorded in the storage unit 11A or an external database or the like and used for the subsequent inference. For example, a comment of a correction instruction “There is no hospital facility in X clinic” may be recorded, and this comment may be used for inference about other target events. As a result, in the subsequent inference (only inference for the same insured person may be used, or inference for other insured persons may be used), it is possible to obtain an inference result based on the fact that there is no hospital facility in the X clinic.

The presentation control unit 104A may present the recorded content of the correction instruction to the insured person, and the reception unit 105A may receive correction, deletion, addition, or the like of the content of the correction instruction. As a result, the content of the correction instruction can be reflected in the subsequent inference without relearning the language model M2 or the like. The correction instruction may be reused by including the correction instruction in the prompt as in the case where the correction instruction is used for the first time. That is, the determination unit 103A may generate a prompt including the recorded correction instruction and instructing to infer the relationship between the target event and the related payment cause based on the correction instruction, input the generated prompt to the language model M2, and output an inference result indicating whether the target event is associated with the related payment cause.

### (Repetition of Inference)

Since the language model M2 is a probabilistic model, inference results in a plurality of inferences can be different from each other even in a case where exactly the same prompt is input. In particular, it is known that there is a tendency that an inference result different from the fact is hardly repeatedly output. Therefore, the determination unit 103A may perform processing of inputting a prompt to the language model M2 and outputting the inference result a plurality of times. In this case, the determination unit 103A may determine that the target event having a large variation in the inference result is not associated with the related payment cause. For example, the determination unit 103A may calculate a score (for example, a ratio of inference results having different contents from other inference results to all the inference results) indicating the magnitude of the variation in the inference result for each target event, and determine that the target event whose calculated score exceeds a predetermined threshold is not associated with the related payment cause.

### (Correction and Supplementation of Description of Target Event)

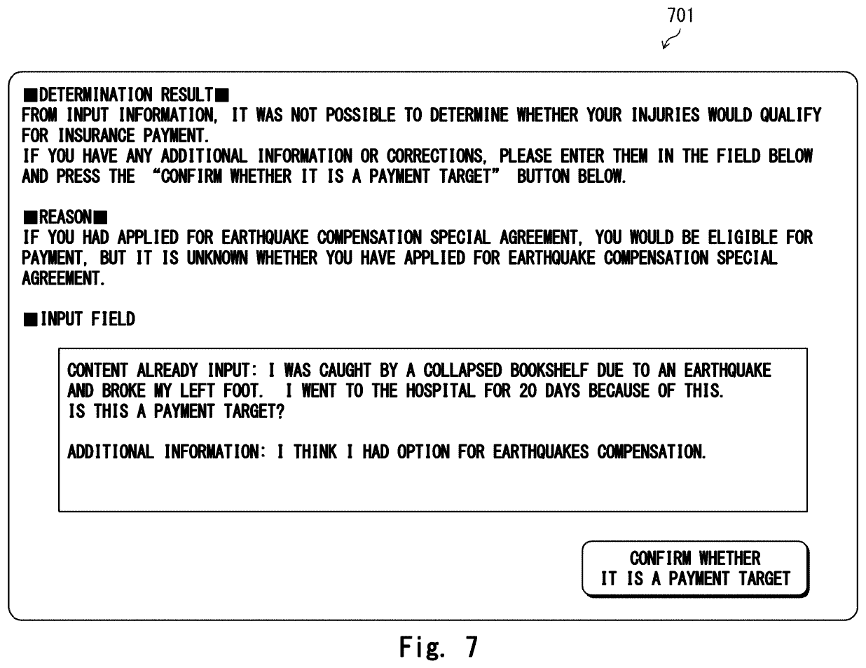

As in the example of FIG. 5, in a case where event information with insufficient explanation of the target event is input, it may be impossible to determine whether the target event is associated with a payment cause, or an erroneous determination result may be output. Therefore, the information processing apparatus 1A may prompt for correction or supplementation of the description of the target event after the determination by the determination unit 103A. This will be described with reference to FIG. 7. FIG. 7 is a diagram illustrating an example of a UI screen that receives correction or supplementation of the description of the target event.

A screen example 701 illustrated in FIG. 7 shows the determination result of determination unit 103A together with its basis (to be precise, the basis of the inference of the language model M2, which is the basis of the determination result). In the screen example 701, a text that prompts the user to input additional information and correction items is illustrated. The screen example 701 also displays a text box for inputting additional information and correction items, and a “confirm whether it is a payment target” button (software key) for confirming whether it is a payment target. In a case of presenting the determination result of the determination unit 103A, the presentation control unit 104A presents a UI screen such as the screen example 701, in such a way that it is possible to withdraw information necessary for obtaining a more appropriate determination result from the insured person.

In the screen example 701, in a case where the button of “confirm whether it is a payment target” is operated in a state where the input event information displayed in the text box is corrected or additional information is input, the acquisition unit 101A acquires the input content as new event information. Thereafter, similarly to the case where the event information has been previously acquired, extraction of the related payment cause by the extraction unit 102A and determination by the determination unit 103A are performed, and a determination result as to whether the target event is associated with the payment cause is presented.

For example, as in the example of FIG. 7, it is assumed that the information regarding the application status of the earthquake compensation special agreement is added without changing the input event information. In this case, similarly to the previous time, the extraction unit 102A extracts a portion describing the earthquake compensation special agreement as a related payment cause. The determination unit 103A generates a prompt that includes the added information and instructs to infer whether the target event is associated with the related payment cause, and inputs the prompt to the language model M2. Here, since the added information indicates that the contract of the earthquake compensation special agreement has been made, the inference result output by the language model M2 indicates that the target event is associated with the related payment cause. Therefore, the determination unit 103A determines that the target event is associated with the related payment cause and causes the presentation control unit 104A to present the determination result.

### (Use of History Information)

The event information acquired by the acquisition unit 101A may be an input of an item considered by the insured person to possibly be associated with the payment cause, may be history information on the injury and illness of the insured person, or may be both of them. Here, in a case where the acquisition unit 101A acquires both the information input by the insured person and the history information as the event information, there may be a case where an item that may be associated with the payment cause is included in the item that is not indicated in the information input by the insured person but is indicated in the history information.

Therefore, the acquisition unit 101A may perform processing of acquiring the target event from the information input by the insured person and acquiring the target event from the history information, and matching these target events. Then, in a case where the target event that has not been acquired from the information input by the insured person but has been acquired from the history information is detected by the above processing, the presentation control unit 104A may present the target event to the insured person and prompt the insured person to confirm whether the target event is a payment target. As a result, it is possible to claim the insurance payment without omission even for an event that the insured person has not recognized as a payment target of the insurance money.

The above-described matching may be omitted, and the related payment cause may be extracted using the history information as it is as the event information. In this case, the extraction unit 102A may perform processing of inputting the event indicated in the history information and the document describing the payment cause of insurance to the extraction model M1 and extracting the related payment cause related to the event for each event indicated in the history information.

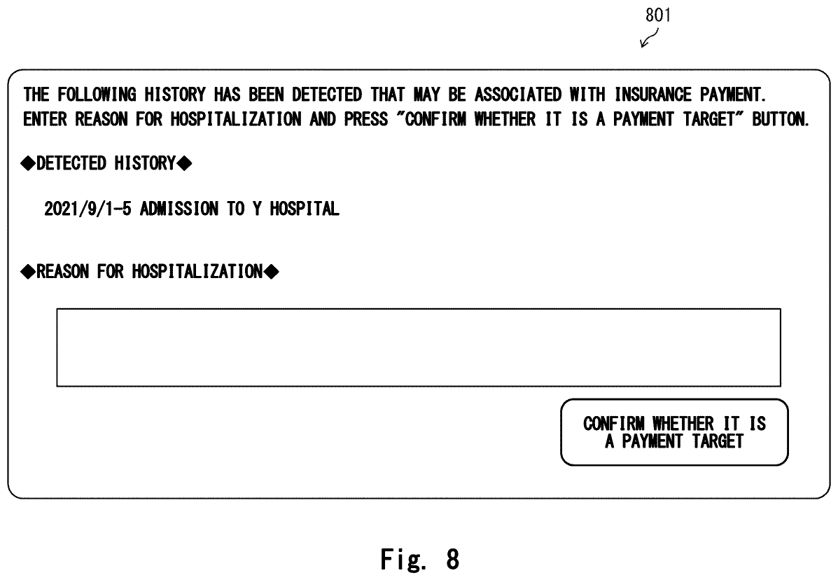

There is a possibility that the history information acquired by the acquisition unit 101A does not include sufficient information for determining whether each event indicated in the history information is associated with the payment cause of insurance. Therefore, the presentation control unit 104A may present the target event acquired from the history information to the insured person and prompt the input of information for determining whether the target event is associated with the payment cause. This will be described with reference to FIG. 8.

FIG. 8 is a diagram illustrating an example of a UI screen that receives an input of an explanatory sentence of history information. In the screen example 801 illustrated in FIG. 8, a text indicating that the history information possibly related to the payment cause has been detected is displayed, and the detected history information is displayed. Specifically, this history information indicates that the patient was admitted to the Y hospital in the period from September 1 to 5 days in 2021.

The screen example 801 displays a text prompting the user to input the reason for the hospitalization and press the “confirm whether it is a payment target” button. The screen example 801 also displays a text box for inputting the reason for hospitalization, and a “confirm whether it is a payment target” button (software key) for instructing determination as to whether the item indicated in the history information is associated with the payment cause, in consideration of the input reason. The reception unit 105A can receive an input of a reason for hospitalization via such a UI screen.

In the screen example 801, in a case where the reason for hospitalization is input in the text box and the button of “confirmation whether it is a payment target” is operated, the extraction unit 102A extracts a related payment cause. In this case, the extraction unit 102A extracts a related payment cause related to the target event, using a set of the detected history information and the input reason for hospitalization as one target event. For example, in a case where the input reason for hospitalization is “heart failure”, the extraction unit 102A inputs a sentence “2021 Sep. 1-5: hospitalized in Y hospital, reason for hospitalization: heart failure” to the extraction model M1 as a target event and extracts a related payment cause. Thereafter, a determination is made by the determination unit 103A, and a determination result as to whether the item indicated in the history information is associated with the related payment cause is presented.

In the example of FIG. 8, the detected history information indicates a history of hospitalization. Therefore, the reception unit 105A receives an input of a reason for hospitalization. As described above, the reception unit 105A only needs to receive input of additional information associated with the content of the history information, in other words, an explanatory sentence describing the history information. For example, in a case where history information indicating a prescription history of a medicine is detected, the reception unit 105A may receive an input of an explanatory sentence for the prescribed medicine.

As described above, the information processing apparatus 1A includes the presentation control unit 104A that presents history information of an insured person regarding a payment cause, and the reception unit 105A that accepts input of an explanatory sentence describing the presented history information. Then, the extraction unit 102A extracts a related payment cause related to the target event, using a set of the history information and the explanatory sentence as one target event. As a result, in addition to the effect obtained by the information processing apparatus 1, it is possible to extract an appropriate related payment cause in consideration of the input explanatory sentence. The determination unit 103A may determine whether the target event including the history information and the explanatory sentence is associated with a related payment cause using the language model M2. As a result, it is possible to obtain an appropriate determination result in consideration of the input explanatory sentence.

### (Flow of Processing)

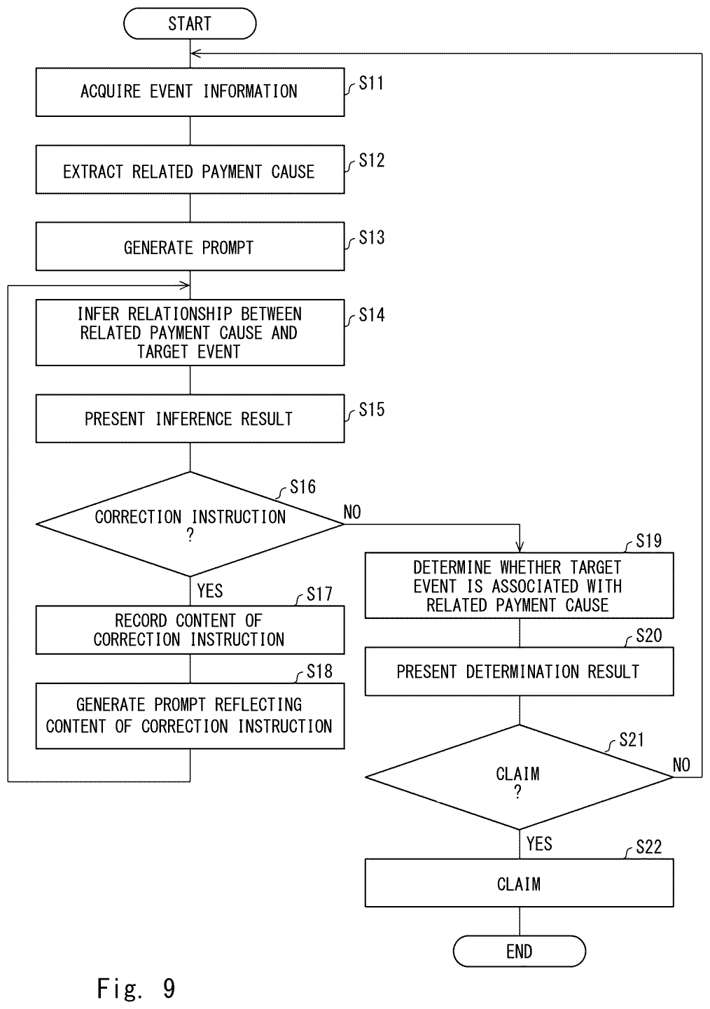

A flow of processing executed by the information processing apparatus 1A will be described with reference to FIG. 9. FIG. 9 is a flowchart illustrating a flow of processing executed by the information processing apparatus 1A. The flowchart of FIG. 9 includes each processing of the support method according to the present exemplary example embodiment.

In S11 (acquisition processing), the acquisition unit 101A acquires event information indicating a target event that is an event that may be associated with a payment cause of insurance. For example, the acquisition unit 101A may acquire event information input by the insured person to the information processing apparatus 1A.

In S12 (extraction processing), the extraction unit 102A extracts a related payment cause which is a payment cause related to a target event indicated in the event information acquired in S11, from the document describing a payment cause of insurance using an extraction model M1 trained by machine learning in such a way as to output a portion related to the data in the document by using a set of the document and data as an input. The document describing the payment cause of insurance may be input together with the event information in S11, or may be acquired from a predetermined database as in the example of FIG. 4.

In S13, the determination unit 103A generates a prompt to be input to the language model M2. Specifically, the determination unit 103A generates a prompt that includes the related payment cause extracted in S12 and the target event indicated in the event information acquired in S11 and instructs to infer the relationship between the related payment cause and the target event, in other words, whether the target event is associated with the related payment cause.

In S14, the determination unit 103A inputs the prompt generated in S13 to the language model M2 to infer the relationship between the related payment cause and the target event. In S15, the presentation control unit 104A presents the inference result of S14 to the insured person. In S16, the reception unit 105A determines whether there is a correction instruction for the inference result presented in S15. If YES is determined in S16, the processing proceeds to S17, and if NO is determined in S16, the processing proceeds to S19.

In S15, the presentation control unit 104A may present the inference result by displaying a UI screen such as the screen example 601 of FIG. 6, for example. In this case, the reception unit 105A may receive the correction instruction via the UI screen. The processing of presenting the inference result may be omitted. In that case, after S14, the processing proceeds to S19.

In S17, the reception unit 105A records the content of the received correction instruction in the storage unit 11A, an external database, or the like. Any timing of recording the content of the correction instruction is applicable. For example, the reception unit 105A may record the content of the correction instruction after the determination described later is completed or after the insurance claim is completed.

In S18, the determination unit 103A generates a prompt reflecting the content of the correction instruction received by the reception unit 105A, specifically, a prompt including the correction instruction and instructing to infer the relationship between the target event and the related payment cause based on the correction instruction. Thereafter, the processing returns to S14, and the determination unit 103A inputs a newly generated prompt to the language model M2 to infer the relationship between the target event and the related payment cause.

In S19, the determination unit 103A determines whether the target event indicated in the event information acquired in S11 is associated with the related payment cause extracted in S12 based on the inference result of the language model M2 (the latest inference result among the plurality of inference results in a case where the inference is performed a plurality of times). Then, in S20, the presentation control unit 104A presents the determination result in S19 to the insured person.

In S21, the claim support unit 106A determines whether to make a claim. If YES is determined in S21, the processing proceeds to S22. On the other hand, if NO is determined in S21, the processing returns to S11.

For example, in a case where the determination unit 103A determines in S19 that the target event is associated with the related payment cause, the presentation control unit 104A may present an option as to whether to make a claim together with the determination result in S20. Then, in a case where the option of making a claim is selected from the presented options, the claim support unit 106A may determine to make a claim in S21.

On the other hand, in a case where the determination unit 103A determines in S19 that the target event is not associated with the related payment cause or cannot determine whether the target event is associated with the related payment cause, the presentation control unit 104A may present the determination result by displaying a UI screen such as a screen example 701 of FIG. 7 in S20. In this case, in S21, the claim support unit 106A may determine not to make a claim.

In S11 proceeding from S21, the acquisition unit 101A acquires new event information. For example, in a case where a UI screen such as the screen example 701 of FIG. 7 is displayed in S20, the acquisition unit 101A may acquire an item input via the UI screen as new event information.

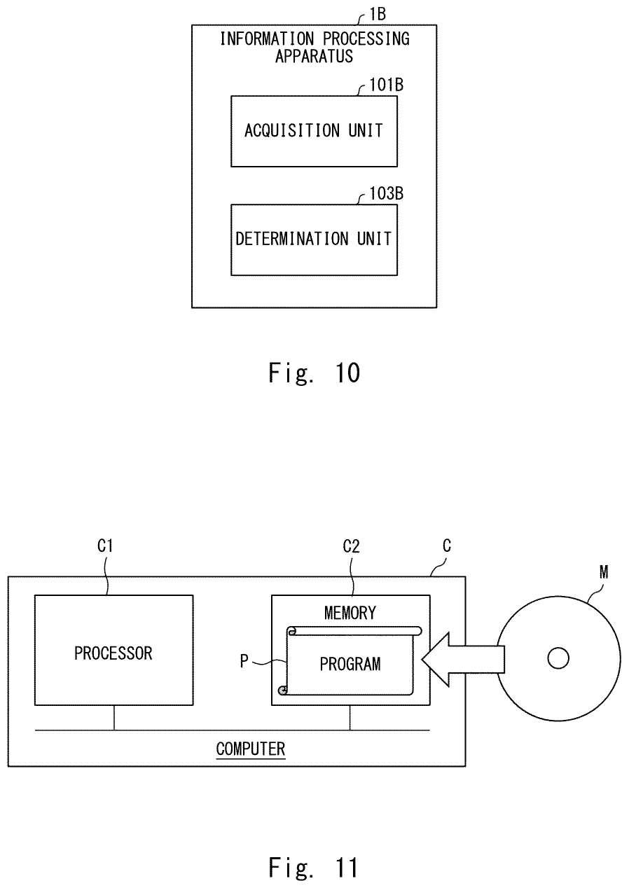

In S22, the claim support unit 106A makes a claim for the target event determined to be claimed in S21. For example, the claim support unit 106A may generate a notification for claiming insurance on the basis that the target event is associated with a related payment cause, and transmit the generated notification to a predetermined destination (insurance company or the like). Accordingly, the processing of FIG. 10 ends.

As described above, the inference result of the language model M2 is not necessarily correct. Therefore, the claim support unit 106A may transmit the event information acquired in S11 and the inference result in S14 together with the notification of the claim as reference information. In a case where the inference basis is output together with the inference result, the claim support unit 106A may also transmit the inference basis as reference information. Accordingly, the payment assessor can appropriately determine whether the target event is associated with the payment cause in consideration of the reference information.

### Reference Example 1

FIG. 10 is a block diagram illustrating a configuration of an information processing apparatus 1B according to the present reference example. As illustrated, the information processing apparatus 1B includes an acquisition unit 101B and a determination unit 103B.

Similarly to the acquisition unit 101A of the second exemplary example embodiment, the acquisition unit 101B acquires event information indicating a target event that is an event that may be associated with a payment cause of insurance.

Similarly to the determination unit 103A of the second exemplary example embodiment, the determination unit 103B determines whether the target event indicated in the event information acquired by the acquisition unit 101B is associated with a payment cause by using a language model trained by machine learning on natural language.

As in the first exemplary example embodiment or the second exemplary example embodiment, the payment cause may be extracted from the document describing the payment cause by using the extraction model (that is, the related payment cause), or may not be extracted by the extraction model. For example, the acquisition unit 101B may acquire a payment cause associated with the target event, in other words, a payment cause for which it is desired to determine whether the target event is associated, in addition to the target event, by causing the insured person to input the payment cause or the like. For example, the determination unit 103B can extract a part of a document describing the payment cause of insurance (for example, a coherent portion of the content such as one sentence or one paragraph) by analyzing the document, and perform the above determination using the part.

As described above, the information processing apparatus 1B includes the acquisition unit 101B that acquires the event information indicating the target event that is the event that may be associated with the payment cause of insurance, and the determination unit 103B that determines whether the target event indicated in the event information acquired by the acquisition unit 101B is associated with the payment cause by using the language model trained by machine learning on natural language. According to the information processing apparatus 1B, it is possible to obtain an objective determination result as to whether the target event is associated with the payment cause. Therefore, it is possible to obtain an effect that the insurance claim can be facilitated.

How to use the determination result of the determination unit 103B to facilitate the claim is optional. For example, the presentation control unit 104A similar to that of the information processing apparatus 1A according to the second exemplary example embodiment may be provided in the information processing apparatus 1B. In this case, the presentation control unit 104A can be caused to present the determination result of the determination unit 103B. As a result, the insured person can consider the claim with reference to the presented determination result.

For example, the information processing apparatus 1B may be provided with a claim support unit 106A similar to the information processing apparatus 1A according to the second exemplary example embodiment. In this case, the claim support unit 106A can be caused to claim the insurance payment for the target event determined to be associated with the payment cause by the determination unit 103B.

### (Support Program)

The above-described functions of the information processing apparatus 1B can also be achieved by a program. A support program according to the present reference example is a support program for an insurance claim, the support program causing a computer to function as: acquisition means for acquiring event information indicating a target event that is an event that may be associated with a payment cause of insurance; and determination means for determining whether the target event indicated in the event information acquired by the acquisition means is associated with the payment cause by using a language model trained by machine learning on natural language. According to this support program, it is possible to obtain an effect of facilitating an insurance claim.

### (Support Method)

A support method according to the present reference example is a support method for an insurance claim, in which at least one processor executes: acquisition processing of acquiring event information indicating a target event that is an event likely to be associated with a payment cause of insurance; and determination processing of determining whether the target event indicated in the event information acquired in the acquisition processing is associated with the payment cause by using a language model trained by machine learning on natural language.

According to this support method, it is possible to obtain an effect of facilitating an insurance claim.

### Reference Example 2

In the above-described exemplary example embodiment, the information processing apparatuses 1 and 1A have been described that acquire the event information indicating the target event that is the event that may be associated with the payment cause of insurance and extract the related payment cause related to the target event from the document describing the payment cause of insurance.

In the reference example described above, the information processing apparatus 1B has been described that acquires the event information indicating the target event that is an event that may be associated with the payment cause of insurance and determines whether the target event is associated with the payment cause.

These information processing apparatuses 1, 1A, and 1B can be used for determination of whether any event satisfies any requirement, in addition to support of an insurance claim. For example, in a case of preparing an application document for a grant, the applicant determines whether the payment requirements are satisfied, and prepares an application document indicating that the requirements are satisfied.

At this time, the applicant may input items that may be associated with the payment requirements to the information processing apparatus 1 or 1A instead of the event information, and may cause the information processing apparatus 1 to refer to a document describing the payment requirements instead of the document describing the payment cause. As a result, it is possible to extract the requirements related to the item input by the applicant among the requirements described in the document describing the payment requirements. Then, by causing the information processing apparatus 1 or 1A to present the extracted requirement, the applicant can smoothly determine whether the requirement is satisfied and efficiently proceed with creation of the application form.

The applicant may input an item that may be associated with the payment requirement to the information processing apparatus 1B instead of the event information, and may cause the information processing apparatus 1B to refer to the payment requirement of the grant. As a result, it is possible to cause the information processing apparatus 1B to output a determination result as to whether the item input by the applicant satisfies the payment requirement. Then, the applicant can efficiently proceed with the creation of the application form with reference to the presented determination result.

In addition, for example, the information processing apparatuses 1, 1A, and 1B can also be used to create a product instruction manual conforming to the description of the specification, create a document conforming to a provision of a law, an ordinance, or the like, and the like. For example, the information processing apparatuses 1, 1A, and 1B can also be used for designing an apparatus or a system conforming to a standard. For example, by using the information processing apparatuses 1 and 1A, it is possible to extract a communication-related description in a standard specification in a case of considering a communication specification in an apparatus or a system. By using the information processing apparatus 1, 1A, or 1B, it is possible to easily confirm whether the design specification conforms to the standard.

### Modified Examples

Any execution subject of each processing described in the above-described exemplary example embodiment and reference example is applicable, and is not limited to the above-described examples. For example, a system having functions similar to those of the information processing apparatuses 1, 1A, and 1B can be constructed by a plurality of apparatuses capable of communicating with each other. The execution subject of each processing illustrated in the flowchart illustrated in FIG. 9 may be one device (also referred to as a processor) or a plurality of apparatuses (also referred to as a processor).

### Example of Implementation by Software

Some or all of the functions of the information processing apparatuses 1, 1A, and 1B (hereinafter also referred to as “each of the above apparatuses”) may be implemented by hardware such as an integrated circuit (IC chip) or may be implemented by software.

In the latter case, each of the above apparatuses is implemented by, for example, a computer that executes a command of a program which is software for implementing each function. An example of such a computer (hereinafter, referred to as a computer C) is illustrated in FIG. 11. FIG. 11 is a block diagram illustrating a hardware configuration of the computer C functioning as each of the above apparatuses.

The computer C includes at least one processor C1 and at least one memory C2. A program (support program) P for operating the computer C as each of the above apparatuses is recorded in the memory C2. In the computer C, the processor C1 reads the program P from the memory C2 and executes the program P to implement each function of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be implemented by one processor provided in one computer, may be implemented in cooperation with a plurality of processors provided in one computer, or may be implemented in cooperation with a plurality of processors provided in a plurality of computers, respectively. The program causing each of the above apparatuses to implement each of the above functions may be stored in one memory provided in one computer, may be stored in a distributed manner in a plurality of memories provided in one computer, or may be stored in a distributed manner in a plurality of memories provided in a plurality of computers, respectively.

### Supplementary Notes

The present disclosure includes the technologies described in the following supplementary notes. However, the present invention is not limited to the techniques described in the following supplementary notes, and various modifications can be made within the scope described in the claims.

### (Supplementary Note A1)

An information processing apparatus including: acquisition means for acquiring event information indicating a target event which is an event likely to be associated with a payment cause of insurance; and extraction means for extracting a related payment cause related to the target event from a document describing a payment cause of insurance using an extraction model trained by machine learning in such a way as to output a portion related to the data in the document using a set of the document and the data as an input.

### (Supplementary Note A2)

The information processing apparatus according to Supplementary Note A1, further including: determination means for determining whether the target event is associated with the related payment cause using a language model trained by machine learning on natural language; and presentation control means for presenting a determination result of the determination means.

### (Supplementary Note A3)

The information processing apparatus according to Supplementary Note A2, in which the determination means generates a prompt that includes the related payment cause and the target event and instructs to infer a relationship between the related payment cause and the target event, and determines whether the target event is associated with the related payment cause based on an output obtained by inputting the generated prompt to the language model.

### (Supplementary Note A4)

The information processing apparatus according to Supplementary Note A3, in which the determination means generates a prompt instructing to output a basis of the inference together with an inference result of the relationship between the related payment cause and the target event, and the presentation control means presents the inference result output by the language model or the determination result by the determination means together with the basis.

### (Supplementary Note A5)

The information processing apparatus according to Supplementary Note A4, further including reception means for receiving a correction instruction for the inference result, in which the determination means redetermines whether the target event is associated with the related payment cause based on the correction instruction received by the reception means.

### (Supplementary Note A6)

The information processing apparatus according to Supplementary Note A5, in which the reception means receives a correction instruction representing a correction content in a natural language, and the determination means generates a prompt including a correction instruction received by the reception means and instructing to infer a relationship between the target event and the related payment cause based on the correction instruction, and redetermines whether the target event is associated with the related payment cause based on an output obtained by inputting the generated prompt to the language model.

### (Supplementary Note A7)

The information processing apparatus according to any one of Supplementary Notes A1to A6, further including: presentation control means for presenting history information indicating a history related to a payment cause of insurance; and reception means for receiving an input of an explanatory sentence describing the presented history information, in which the extraction means extracts a related payment cause related to the target event, using a set of the history information and the explanatory sentence as one target event.

### (Supplementary Note A8)

An information processing apparatus including: acquisition means for acquiring event information indicating a target event which is an event likely to be associated with a payment cause of insurance; and determination means for determining whether the target event is associated with the payment cause using a language model trained by machine learning on natural language.

### (Supplementary Note B1)

A support method causing at least one processor to execute: acquisition processing for acquiring event information indicating a target event which is an event likely to be associated with a payment cause of insurance; and extraction processing for extracting a related payment cause related to the target event from a document describing a payment cause of insurance using an extraction model trained by machine learning in such a way as to output a portion related to the data in the document using a set of the document and the data as an input.

### (Supplementary Note B2)

The support method according to Supplementary Note B1, in which the at least one processor includes determination processing for determining whether the target event is associated with the related payment cause by using a language model trained by machine learning on natural language, and the at least one processor includes presentation control processing for presenting the determination result of the determination processing.

### (Supplementary Note B3)

The support method according to Supplementary Note B2, in which in the determination processing, the at least one processor generates a prompt that includes the related payment cause and the target event and instructs to infer a relationship between the related payment cause and the target event, and determines whether the target event is associated with the related payment cause based on an output obtained by inputting the generated prompt to the language model.

### (Supplementary Note B4)

The support method according to Supplementary Note B3, in which in the determination processing, the at least one processor generates a prompt instructing to output a basis of the inference together with an inference result of the relationship between the related payment cause and the target event, and the at least one processor presents the inference result output by the language model or the determination result by the determination processing together with the basis.

### (Supplementary Note B5)

The support method according to Supplementary Note B4, in which the at least one processor includes reception processing of receiving a correction instruction for the inference result, and the at least one processor redetermines whether the target event is associated with the related payment cause based on the correction instruction received in the reception processing.

### (Supplementary Note B6)

The support method according to Supplementary Note B5, in which in the reception processing, the at least one processor receives a correction instruction representing a correction content in a natural language, and the at least one processor generates a prompt including the correction instruction received in the reception processing and instructing to infer a relationship between the target event and the related payment cause based on the correction instruction, and redetermines whether the target event is associated with the related payment cause based on an output obtained by inputting the generated prompt into the language model.

### (Supplementary Note B7)

The support method according to any one of Supplementary Notes B1 to B6, in which the at least one processor includes presentation control processing for presenting history information indicating a history related to the payment cause of insurance, the at least one processor includes reception processing for receiving an input of an explanatory sentence describing the presented history information, and in the extraction processing, the at least one processor extracts a related payment cause related to the target event by using a set of the history information and the explanatory sentence as one target event.

### (Supplementary Note B8)

A support method causing at least one processor to execute acquisition processing for acquiring event information indicating a target event which is an event likely to be associated with a payment cause of insurance; and the at least one processor to execute determination processing for determining whether the target event is associated with the payment cause using a language model trained by machine learning on natural language.

### (Supplementary Note C1)

A support program causing a computer to function as: acquisition means for acquiring event information indicating a target event which is an event likely to be associated with a payment cause of insurance; and extraction means for extracting a related payment cause related to the target event from a document describing a payment cause of insurance using an extraction model trained by machine learning in such a way as to output a portion related to the data in the document using a set of the document and the data as an input.

### (Supplementary Note C2)

The support program according to Supplementary Note C1, causing the computer to function as determination means for determining whether the target event is associated with the related payment cause using a language model trained by machine learning on natural language; and presentation control means for presenting a determination result of the determination means.

### (Supplementary Note C3)

The support program according to Supplementary Note C2, in which the determination means generates a prompt that includes the related payment cause and the target event and instructs to infer a relationship between the related payment cause and the target event, and determines whether the target event is associated with the related payment cause based on an output obtained by inputting the generated prompt to the language model.

### (Supplementary Note C4)

The support program according to Supplementary Note C3, in which the determination means generates a prompt instructing to output a basis of the inference together with an inference result of a relationship between the related payment cause and the target event, and the presentation control means presents the inference result output by the language model or the determination result by the determination means together with the basis.

### (Supplementary Note C5)

The support program according to Supplementary Note C4, causing the computer to function as reception means for receiving a correction instruction for the inference result, in which the determination means redetermines whether the target event is associated with the related payment cause based on the correction instruction received by the reception means.

### (Supplementary Note C6)

The support program according to Supplementary Note C5, in which the reception means receives a correction instruction representing a correction content in a natural language, and the determination means generates a prompt including a correction instruction received by the reception means and instructing to infer a relationship between the target event and the related payment cause based on the correction instruction, and redetermines whether the target event is associated with the related payment cause based on an output obtained by inputting the generated prompt to the language model.

### (Supplementary Note C7)

The support program according to any one of Supplementary Notes C1 to C6, causing the computer to function as presentation control means for presenting history information indicating a history related to the payment cause of insurance, and reception means for receiving an input of an explanatory sentence describing the presented history information, in which the extraction means extracts a related payment cause related to the target event by using a set of the history information and the explanatory sentence as one of the target events.

### (Supplementary Note C8)

A support program causing the computer to function as acquisition means for acquiring event information indicating a target event which is an event likely to be associated with a payment cause of insurance; and determination means for determining whether the target event is associated with the payment cause using a language model trained by machine learning on natural language.

### (Supplementary Note D1)

An information processing apparatus including at least one processor for causing the at least one processor to execute: acquisition processing for acquiring event information indicating a target event which is an event likely to be associated with a payment cause of insurance; and extraction processing for extracting a related payment cause related to the target event from a document describing a payment cause of insurance using an extraction model trained by machine learning in such a way as to output a portion related to the data in the document using a set of the document and the data as an input.

The information processing apparatus may further include a memory. The memory may store a program for causing the at least one processor to execute each of the processing.

### (Supplementary Note D2)

The information processing apparatus according to Supplementary Note D1, in which the at least one processor executes determination processing for determining whether the target event is associated with the related payment cause by using a language model trained by machine learning on natural language, and presentation control processing for presenting the determination result of the determination processing.

### (Supplementary Note D3)

The information processing apparatus according to Supplementary Note D2, in which in the determination processing, the at least one processor generates a prompt that includes the related payment cause and the target event and instructs to infer a relationship between the related payment cause and the target event, and determines whether the target event is associated with the related payment cause based on an output obtained by inputting the generated prompt to the language model.

### (Supplementary Note D4)

The information processing apparatus according to Supplementary Note D3, in which in the determination processing, the at least one processor generates a prompt instructing to output a basis of the inference together with an inference result of the relationship between the related payment cause and the target event, and the at least one processor presents the inference result output by the language model or the determination result by the determination processing together with the basis.

### (Supplementary Note D5)

The information processing apparatus according to Supplementary Note D4, in which the at least one processor executes reception processing of receiving a correction instruction for the inference result, and the at least one processor redetermines whether the target event is associated with the related payment cause based on the correction instruction received in the reception processing.

### (Supplementary Note D6)

The information processing apparatus according to Supplementary Note D5, in which in the reception processing, the at least one processor receives a correction instruction representing a correction content in a natural language, and the at least one processor generates a prompt including the correction instruction received in the reception processing and instructing to infer a relationship between the target event and the related payment cause based on the correction instruction, and redetermines whether the target event is associated with the related payment cause based on an output obtained by inputting the generated prompt into the language model.

### (Supplementary Note D7)

The information processing apparatus according to any one of Supplementary Notes D1 to D6, in which the at least one processor executes presentation control processing for presenting history information indicating a history related to the payment cause of insurance, and reception processing for receiving an input of an explanatory sentence describing the presented history information, and in the extraction processing, the at least one processor extracts a related payment cause related to the target event by using a set of the history information and the explanatory sentence as one target event.

### (Supplementary Note D8)

An information processing apparatus including at least one processor, the at least one processor executes acquisition processing for acquiring event information indicating a target event which is an event likely to be associated with a payment cause of insurance; and determination processing for determining whether the target event is associated with the payment cause using a language model trained by machine learning on natural language.

### (Supplementary Note E1)

A non-transitory recording medium recording a support program for causing a computer to execute acquisition processing for acquiring event information indicating a target event which is an event likely to be associated with a payment cause of insurance; and extraction processing for extracting a related payment cause related to the target event from a document describing a payment cause of insurance using an extraction model trained by machine learning in such a way as to output a portion related to the data in the document using a set of the document and the data as an input.

### (Supplementary Note E2)

A non-transitory recording medium recording a support program for causing a computer to execute: an acquisition process of acquiring event information indicating a target event that is an event that may be associated with a payment cause of insurance; and a determination process of determining whether the target event is associated with the payment cause by using a language model obtained by machine learning of natural language.

1. An information processing apparatus comprising:
at least one memory storing instructions; and
at least one processor configured to execute the instructions to;
acquire event information indicating a target event which is an event likely to be associated with a payment cause of insurance; and
extract a related payment cause related to the target event from a document in which a payment cause of insurance is described using an extraction model trained by machine learning in such a way as to output a portion related to the data in the document using a set of the document and the data as an input.

2. The information processing apparatus according to claim 1, wherein the at least one processor is further configured to execute the instructions to
determine whether the target event is associated with the related payment cause using a language model trained by machine learning on natural language; and
present a determination result.

3. The information processing apparatus according to claim 2, wherein the at least one processor is further configured to execute the instructions to
generate a prompt that includes the related payment cause and the target event and instructs to infer a relationship between the related payment cause and the target event; and
determine whether the target event is associated with the related payment cause based on an output obtained by inputting the generated prompt to the language model.

4. The information processing apparatus according to claim 3, wherein the at least one processor is further configured to execute the instructions to
generate a prompt instructing to output a basis of the inference together with an inference result of the relationship between the related payment cause and the target event; and
present the inference result output by the language model or the determination result together with the basis.

5. The information processing apparatus according to claim 4, wherein the at least one processor is further configured to execute the instructions to
receive a correction instruction for the inference result; and
redetermine whether the target event is associated with the related payment cause based on the correction instruction.

6. The information processing apparatus according to claim 5, wherein the at least one processor is further configured to execute the instructions to
receive a correction instruction representing a correction content in a natural language;
generate a prompt including a correction instruction and instructing to infer a relationship between the target event and the related payment cause based on the correction instruction; and
redetermine whether the target event is associated with the related payment cause based on an output obtained by inputting the generated prompt to the language model.

7. The information processing apparatus according to claim 1, wherein the at least one processor is further configured to execute the instructions to
present history information indicating a history related to a payment cause of insurance;
receiving an input of an explanatory sentence describing the presented history information; and
extract a related payment cause related to the target event, using a set of the history information and the explanatory sentence as one target event.

8. A support method causing at least one processor to execute:
acquisition processing for acquiring event information indicating a target event which is an event likely to be associated with a payment cause of insurance; and
extraction processing for extracting a related payment cause related to the target event from a document describing a payment cause of insurance using an extraction model trained by machine learning in such a way as to output a portion related to the data in the document using a set of the document and the data as an input.

9. A non-transitory recording medium recording a support program for causing a computer to execute:
acquisition processing for acquiring event information indicating a target event which is an event likely to be associated with a payment cause of insurance; and
extraction processing for extracting a related payment cause related to the target event from a document describing a payment cause of insurance using an extraction model trained by machine learning in such a way as to output a portion related to the data in the document using a set of the document and the data as an input.
